(19) United States
(12) Patent Application Publication
(10) Pub. No.: US 2006/0281507 A1
(43) Pub. Date: Dec. 14, 2006

(54) Game apparatus

(76) Inventor: Paul Adams, Kent (GB)

Correspondence Address: BUCKLEY, MASCHOFF, TALWALKAR LLC, 5 ELM STREET, NEW CANAAN, CT, 06840, US

(21) Appl. No.: 10/552,519

(22) PCT Filed: Apr. 6, 2004
(86) PCT No.: PCT/GB04/01515

§ 371 Date: Oct. 31, 2005

(30) Foreign Application Priority Data
Apr. 10, 2003 (GB) 0308332.6

(51) Int. Cl. A63F 13/00

(52) U.S. Cl. 463/6

(57) ABSTRACT

An electronic game apparatus is provided, comprising an array of indicators, including at least two different types of indicator; at least two sets of player operable switches, each set of switches including sensors corresponding to each type of indicator; and, a microprocessor, the microprocessor connected to each of the indicators and each of the switches and operable to control the activation of each indicator, and to change game state in response to the operation of a switch in dependence on the correspondence between the operated switch and an activated indicator. The game apparatus of the invention can be operated in a number of modes for one, two or multiple players.

### FIELD OF THE INVENTION

The present invention relates to a game apparatus, and more specifically to an improved form of a game apparatus where an electronic device is used to provide control of various lights and sounds and respond to user inputs.

### BACKGROUND OF THE INVENTION

Children's games are more fun and more effective when they are both easy to use and have features which engage the attention of the user. It is also desirable that the game should be easy to learn but remain captivating as the participants gain greater skill through repeated use. Whilst there are many games which may be said to fulfill these requirements they often require multiple pieces and complex arrangements.

It is also desirable in a game that it be compact and easily packaged, be affordable, and be easy to understand and enjoyable for young and old, male and female without any language barriers. The present invention aims to provide all of these attributes.

### SUMMARY OF THE INVENTION

According to the present invention, an electronic game apparatus comprises:

an array of indicators, including at least two different types of indicator;

at least two sets of player operable switches, each set of switches including sensors corresponding to each type of indicator; and,

a microprocessor, the microprocessor connected to each of the indicators and each of the switches and operable to control the activation of each indicator, and to change game state in response to the operation of a switch in dependence on the correspondence between the operated switch and an activated indicator.

The game state may include the particular indicator which is next activated, the row in which the next indicator is activated, the game score, or any other aspect of the microprocessor's control over the activation of the array of indicators.

Preferably, the switches are pressure sensitive switches. Preferably, the indicators are light emitting devices of different colours and/or brightness. As an alternative, the indicators could emit different pitch sounds or a combination of light and sound.

Preferably, the microprocessor is placed in a fully integrated control box.

Preferably, the array of indicators and the sets of player operable switches are arranged on a three stage board or mat. Each set of player operable switches may be placed on a separate mat or board to the indicators and each other, with each mat or board connected to another by cables and integrated plugs and sockets. Alternatively, they may be arranged on a single mat. In one version of the game, the player operable switches may be pressure sensors designed to be activated by the feet of players, the indicators and switches being arranged on a mat made of a flexible material such as vinyl. In another version of the game, the indicators and sensors may be arranged on a table top board, the sensors being designed to be activated by the hands or fingertips of players. In a further version of the game, the array of indicators and sets of switches may be embodied in software and appear on a computer screen, with the switches formed on a touch screen. Alternatively, the indicators could appear on the computer screen and the switches be keys on a keypad.

Preferably, the array of indicators is arranged to form a plurality of rows of indicators, the game state determining in which row the activated indicator lies.

Preferably, the microprocessor and indicators are battery operated. Alternatively, the microprocessor and indicators may be powered from the mains. Preferably, the microprocessor includes an ON-OFF and RESET switch facility. Preferably, the microprocessor includes a display, the display indicating the game state or game score. Preferably, the microprocessor includes a number of input switches, allowing the user to select the game mode, and allowing the players to pause and restart the game.

Preferably, the microprocessor includes software which generates a random sequence which is used to control the activation of the indicators. This ensures that the activation of the indicators is different from game to game and cannot be predicted by players.

Preferably, the indicators are light emitting diodes (LEDs). Preferably, the user operable switches are coloured corresponding to the colours of the indicators. If a particular colour light is illuminated then actuation of a corresponding coloured switch will be detected by the microprocessor and the game state subsequently altered.

Preferably, the control box includes audio means to emit an array of sounds during a game. Preferably, the control box includes an ON-OFF switch for the audio means to allow the unit to operate in silent mode. Preferably, is programmed so that there is a five second delay between the activation of a game and the commencement of play.

### BRIEF DESCRIPTION OF THE DRAWINGS

Examples of the present invention will now be described in detail with reference to the accompanying drawings, in which:

FIG. 1 shows a game apparatus according to a first embodiment of the present invention;

FIG. 2 is a flow diagram showing the progress of the game of FIG. 1 in one particular game mode;

FIG. 3 is a schematic diagram showing the connections between the various elements of the game apparatus of FIG. 1; and,

FIG. 4 shows a second embodiment of the present invention.

### DETAILED DESCRIPTION

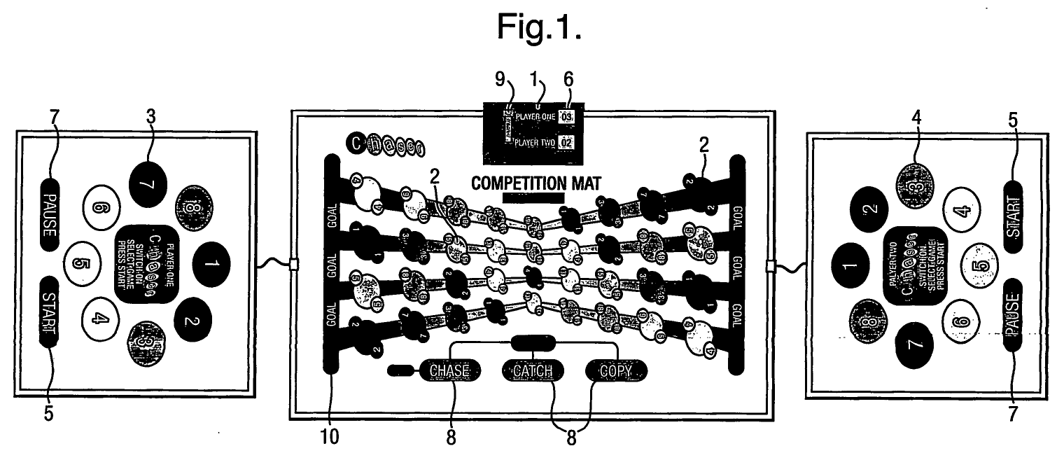

FIG. 1 shows a game apparatus according to a first embodiment of the present invention. The game apparatus shown in FIG. 1 comprises three laminated, vinyl/conductive carbon mats, a central game mat and two player mats. The mats are made non-slip on the underside. The game mat includes a microprocessor 1, an array of coloured lights 2 and the player mats each include a sets of corresponding pressure sensors 3,4. As shown, each set of pressure sensors is identical and includes eight different coloured sensors. The array of indicators includes thirty six lights of eight different colours, 4 or 5 of each colour. The number of lights and sensors can of course be chosen according to preference. The lights are light emitting diodes (LEDs) but may be any kind of light emitting device. Also shown are a power switch 9, start switches 5, a score display 6, game pause buttons 7 which allow the game to be paused and mode buttons 8 which allow different modes to be selected.

Each of the lights are connected to the microprocessor via wires embedded in the game mat and/or via a conductive carbon membrane/laminate. The sensors are similarly connected to the microprocessor 1 via wires embedded in the mats and wires and integrated plugs/sockets between the game and player mats. The microprocessor receives signals from the circuits including each pressure sensor when the pressure sensors are actuated.

In one mode, (entitled ‘CHASE’) the game is to be played by two players, Player 1 and Player 2, each having their own set of sensors 3,4. The sensors are to be operated by the players' feet. The game is started by the switching of a start switch 5. There is a delay of five seconds to allow the players to take up their respective positions and ready themselves to commence play (as signalled by the verbal audio announcement “Let's Play” emitted from the control box). The microprocessor then causes a light in the central row of the array of lights to be illuminated. It could be any one of the four lights shown in the sensor array, the choice being made by the microprocessor on the basis of a random number generation. In this example a red light is illuminated. The players compete to be the first to depress their corresponding pressure sensor, i.e. their red coloured pressure sensor.

The microprocessor determines which player has pressed the correct sensor is first. As a result of that determination, the existing light goes out and another light is illuminated. If Player 1 was the first to depress the correct sensor in response to the previous illuminated light then the microprocessor selects a light in the row adjacent the centre row but closer to Player 2. In other words, the player that reacts the fastest advances the next light to be lit into the next row on the play grid towards their opponent. If Player 2 was successful in response to the illuminated light then a light in a row adjacent to the central row but closer to player one would be selected. The light that is illuminated in each row is selected on a purely random basis as controlled by the microprocessor and may be different every time the game is played.

The process is then repeated with the next light to be illuminated being in a row adjacent to the previous light but closer to the unsuccessful player. The game is concluded when a light is illuminated in the goal area 10. The board size and more particularly the number of rows of lights can be chosen to make a game longer or shorter. Also the game may be set up so that next light to be illuminated is in a row adjacent to the previous light but closer to the successful player.

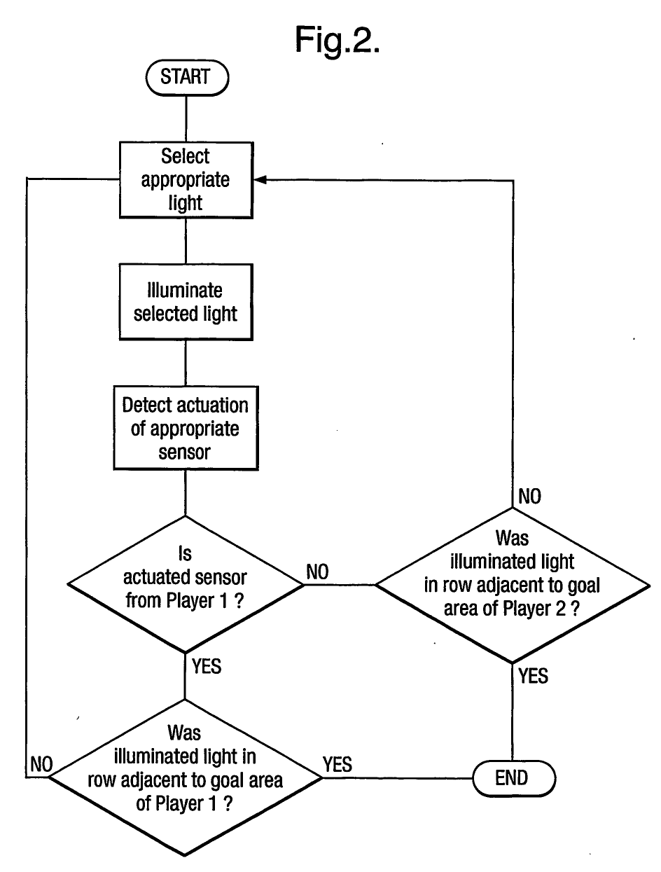

FIG. 2 is a flow diagram showing the steps the processor performs during a game in this mode. The game is started and the microprocessor selects an appropriate light to illuminate, i.e. one from the central row equidistant from both players. The light is then illuminated and the actuation of the sensors detected. The microprocessor then determines which was the first correct sensor to be depressed. If it was a sensor from Player 1, then the microprocessor asks whether the light was adjacent the goal area of Player 1 i.e. whether the light was in the row closest to Player 2. If yes, then Player 1 has won the game and the game ends. If no, then the game proceeds with the illumination of another light in the row adjacent to the previous light but closer to Player 1's goal area. Similar steps are taken if Player 2 is successful in actuating the correct sensor first.

As a sub-level addition to the ‘Chase’ game mode a single player can play against the microprocessor at various levels of difficulty. This ‘play-alone’ option is entitled ‘SOLO’. The microprocessor can be programmed to give the player a set time to actuate the correct sensor. If the player succeeds the next light illuminated is in the row one closer to his goal area. If the player fails the next light illuminated is in the row one closer to the player. The game ends when a goal area is reached.

In another mode, (entitled ‘CATCH’) the game is played by a single player against the clock. The microprocessor controls the illumination of random lights in the array for a predetermined time. The player must actuate the corresponding sensor to the illuminated light before the next light is illuminated. Points are scored, and recorded on a digital display unit, for each successful hit. Players can compete against each other by comparing their scores. The level of difficulty can be set according to the speed of illumination of the lights. In the preferred example, there are 8 pre-set levels of difficulty resulting in 8 levels of pre-set frequencies of illuminations, for example, in the easiest level there are 25 lights illuminated within a minute and in the hardest level there are 60. The speed of the levels is simply a programming choice. The player positions themself in a start position and there is a 5 second time delay before the game starts after actuation of the start switch and play level selector. The game ends after a predetermined number of lights have been illuminated within a set time duration of precisely one minute.

In a third mode, (entitled ‘COPY’) the game is intended to be played by a single player. In this mode the idea of the game is for the player to copy the sequence of illuminations which are produced by the microprocessor. The microprocessor illuminates a pattern of lights in a random sequence. A pre-selected level of playing difficulty controls the speed, length and complexity of the sequence. The player positions themself in a start position and there is a 5 second time delay before the game starts after actuation of the start switch and play level selector. The object is for the player to memorise the random sequence in which the lights are illuminated and to copy the pattern exactly on the sensor pads. Points are scored for each successful attempt.

The game apparatus of the present invention can be provided on mats, as described above, designed so that the pressure sensors are actuated by the feet of a user. The foot operated model could come in a number of sizes but the appropriate dimensions of the game mat is about 3 metres by 1 metre. Alternatively, the game could be made in a table top version (approximate dimensions 1200×300 mm) with the switches designed to be actuated by the fingertips of the player. The lights could be simple LEDs. It is also possible that a miniature travel pack version could be made with an even more compact arrangement of switches.

The game apparatus of the present invention could also be provided in software to appear on a computer screen. The switches could be actual buttons on the game apparatus or could be provided on a touch sensitive screen. The lights could be represented simply on a screen or be replaced by more elaborate icons. The game could be provided as a video game to be played in the home or alternatively in an arcade version in a stand alone machine with the game embodied in a mixture of software and hardware. The modes of operation are the same, the game testing the reactions of the players.

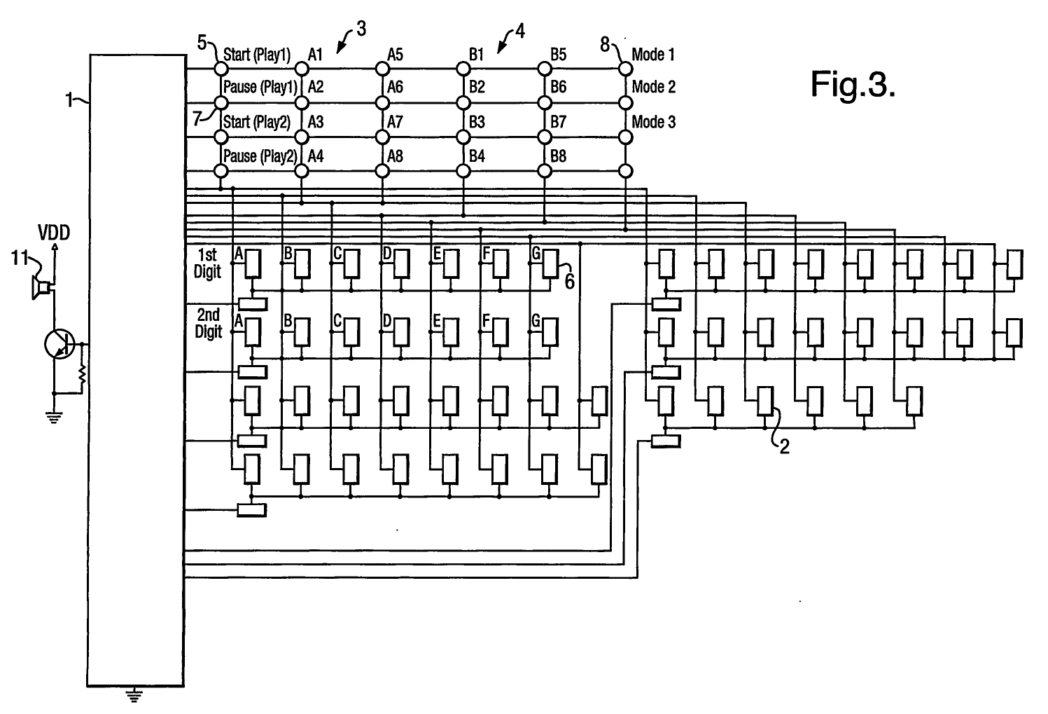

FIG. 3 shows a circuit diagram of the apparatus of FIG. 1. The microprocessor 1 (Chip SNC5X8) is connected in parallel to each of the lights (LEDs) 2. The circuit diagram also includes 14 boxes, labeled 1^{st} digit A-G and 2^{nd} digit A-G. These are the LEDs that form the two digits of the score display 6. The illumination of the LEDs in the score display is also controlled by the microprocessor 1.

FIG. 3 also shows the switches 3, 4 and the start 5, pause 7 and mode 8 buttons. These are shown in a 6×4 grid connected to the microprocessor. The switches for player 1 are labeled A1-A8 and the switches for player 2 are labeled B1-BB. The microprocessor controls the illumination of the LEDs in dependence on the operation of the grid of switches.

A loud speaker 11 is also shown which can add a further level of excitement to the game. The loud speaker is controlled by the microprocessor and can be used to announce the start and end of games or to indicate when a correct switch has been operated. The loud speaker is housed within the control box.

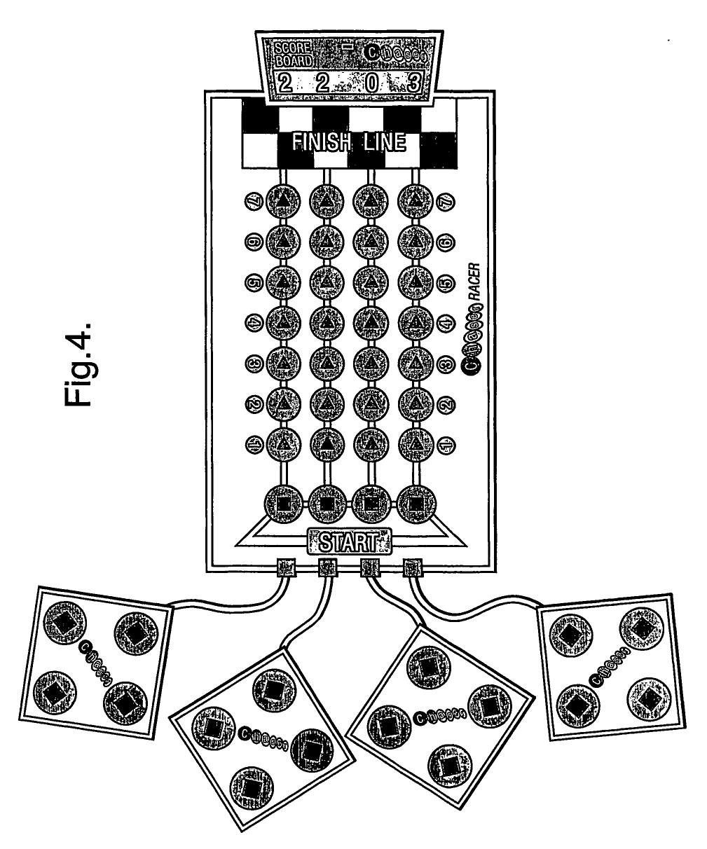

FIG. 4 shows a second embodiment of the invention, with the working title ‘CHASERracer’. In this embodiment the game can be played by 2 to 4 players in a head-to-head race. There are four separate player mats, made from durable, non-slip, laminated vinyl/conductive-carbon material and are connected to the ‘race’ mat (similarly constructed) by cables and plugs. This provides versatility so that they can be placed around it to suit the domestic arena in which the game is to be played. Each player occupies one of the four player mats and they adopt the primary colour of this particular mat as their own for the game in play. The arrangement of the four colour-coded sensors on each play-station is identical.

The ‘race’ mat also incorporates a fully integrated electronic microprocessor (battery and/or mains operated), an ON-OFF and RESET switch plus a digital LED number display to record the scores achieved for each player. The microprocessor also has an ON-OFF switch for the audio speaker to allow the unit to run in silent-mode.

The purpose of the game is for the players to compete against each other in a race to the finishing line. Each player mat is a particular primary colour corresponding to the colours of the lights on the ‘race’ mat. Each player controls the progress of their own colour up the race track towards the winning line. They do this by reacting to the random illumination of 4 colour-coded lights sited at the race mat ‘start’ control that correspond to the same colours featured on each of the individual play-station sensor mats (ie. red-green-blue-yellow). If their own colour light illuminates on the race mat and they react first to press the corresponding colour on their sensor pad, they move their own light forward to the next light. The next light on their personal colour line flashes to show where they are up the race track. Conversely, if an opponent reacts to the light before they do, they ‘block’ the progress of that particular light up the race track. Consequently, the player fastest to respond to the random illumination of the four colour-coded lights at the start of the race mat should move their own light up the race track quicker than their fellow competitors and advance the eight progressions required to win the game. The number of players and the length of the race track can be chosen according to preference. The same basic play strategy applies to all the players taking part irrespective of which primary colour play-station they occupy.

The microprocessor controls the illumination of the lights in a similar fashion to that described with reference to the first embodiment. Furthermore, the second embodiment can similarly be made in a number of different sizes for foot operation or hand operation of the switches, on a computer or as an arcade game.

1. An electronic game apparatus comprising:
an array of indicators, including at least two different types of indicator;
at least two sets of player operable switches, each set of switches including sensors corresponding to each type of indicator; and,
a microprocessor, the microprocessor connected to each of the indicators and each of the switches and operable to control the activation of each indicator, and to change game state in response to the operation of a switch in dependence on the correspondence between the operated switch and an activated indicator.

2. An electronic game apparatus according to claim 1, wherein the switches are pressure sensitive switches.

3. An electronic game apparatus according to claim 1, wherein the indicators are light emitting devices of different colours and/or brightness.

4. An electronic game apparatus according to claim 1, wherein the indicators emit different pitch sounds.

5. An electronic game apparatus according to claim 1, wherein the array of indicators and the sets of player operable switches are arranged on a three stage board or mat.

6. An electronic game apparatus according to claim 1, wherein the indicators and switches are arranged on a mat or mats made of a laminated vinyl/conductive carbon membrane.

7. An electronic game apparatus according to claim 1, wherein the player operable switches are pressure sensors designed to be activated by the feet of players.

8. An electronic game apparatus according to claim 1, wherein the indicators and sensors are arranged on a table top board, the sensors being designed to be activated by the hands or fingertips of players.

9. An electronic game apparatus according to claim 1, wherein the indicators are light emitting diodes (LEDs).

10. An electronic game apparatus according to claim 1, wherein the array of indicators and sets of switches are embodied in software and appear on a computer screen, with the switches formed on a touch screen.

11. An electronic game apparatus according to claim 1, wherein the array of indicators and sets of switches are embodied in software, the indicators appearing on a computer screen and the switches being keys on a keypad.

12. An electronic game apparatus according to claim 1, wherein the array of indicators is arranged to form a plurality of rows of indicators, the game state determining in which row the activated indicator lies.

13. An electronic game apparatus according to claim 1, wherein the microprocessor includes software which generates a random sequence which is used to control the activation of the indicators.

14. An electronic game apparatus according to claim 1, wherein the user operable switches are coloured corresponding to the colours of the indicators.
